(19) United States
(12) Patent Application Publication
(10) Pub. No.: US 2025/0104506 A1
(43) Pub. Date: Mar. 27, 2025

(54) GAMING MACHINE, METHOD FOR PROVIDING GAME, AND PROGRAM

(71) Applicant: Konami Gaming, Inc., Las Vegas, NV (US)

(72) Inventor: Hiraku KUDO, Zama-shi (JP)

(21) Appl. No.: 18/895,280

(22) Filed: Sep. 24, 2024

(30) Foreign Application Priority Data
Sep. 26, 2023 (JP) 2023-162899

(51) Int. Cl. G07F 17/32

(52) U.S. Cl. CPC G07F 17/3213; G07F 17/3244

(57) ABSTRACT

A gaming machine is described herein. The gaming machine includes a control unit that spins and stops a plurality of reels, and provides a game that awards a prize for the arrangement of symbols formed in a first symbol display area by the plurality of reels that have been stopped. The control unit stops the special reel first among the plurality of reels spun in the first symbol display area, further displays, in response to a special symbol stopping on the special reel, a second symbol display area that duplicates the special reel that has been stopped in the first symbol display area and the reels that are spinning, stops reels that are spinning in the first symbol display area and the second symbol display area.

### CROSS REFERENCE TO RELATED APPLICATION

This application claims priority to Japanese Patent Application No. 2023-162899, filed Sep. 26, 2023, the disclosure of which is hereby incorporated by reference in its entirety.

### TECHNICAL FIELD

The present disclosure relates to a gaming machine, a method for providing a game, and a program.

### BACKGROUND OF THE INVENTION

Patent document 1 discloses a slot machine that displays four or eight symbol display ranges during free games to play four or eight games simultaneously. Patent Document 1 also discloses a free feature game that simultaneously offers multiple instances of these games if any of the results of games performed at the same time contain a trigger symbol. Also disclosed are the use of super trigger symbols that provide more game instances than regular trigger symbols and extreme trigger symbols that provide more game instances than super trigger symbols.
Patent Document 1: U.S. Pat. No. 11,488,452 B2.

### SUMMARY OF THE INVENTION

The feature game in the slot machine described in Patent Document 1 provides a predetermined number of the same game in which the trigger symbol appeared at the same time, and thus can provide the expectation that a game will appear a predetermined multiple of times. However, the feature game in Patent Document 1 renders the screen once again with as many symbol display regions as the number of game instances on offer after the game results include a trigger symbol, and displays animation of reel spins starting and stopping in each of them. As a result, the player may find the game to be dull. Also, as the multiple games on offer by the featured game are independent of each other and have no special conditions or common elements, the games merely provide the sum of the anticipation and value one would get from multiple games on offer at the same time. In view of these circumstances, it is an object of the present disclosure to provide a gaming machine, a method for providing a game, and a program that can provide a feature game with a new twist that sustains and increases player interest. This feature game can provide players with a sense of anticipation and value that exceeds the sum of games simultaneously on offer at a fast pace and without pause.

An aspect of the present disclosure is a gaming machine comprising: a control panel that accepts player operations; a display unit having a first symbol display area that partially displays a plurality of reels each having symbols, the plurality of reels including a special reel having a special symbol; and a control unit connected to the control panel and the display unit that spins and stops the plurality of reels in response to a player operating the control panel, and that provides a game that awards a prize for the arrangement of symbols formed in the first symbol display area by the plurality of reels that have been stopped, wherein the control unit stops the special reel first among the plurality of reels spun in the first symbol display area, further displays, in response to a special symbol stopping on the special reel, a second symbol display area that duplicates the special reel that has been stopped in the first symbol display area and the reels that are spinning, stops reels that are spinning in the first symbol display area and the second symbol display area, and provides a first game feature that awards a prize for the arrangement of symbols formed in the first symbol display area and the second symbol display area.

Another aspect of the present disclosure is a gaming machine comprising: a control panel that accepts player operations; a display unit having a symbol display area that partially displays a plurality of reels each having symbols, the plurality of reels including a special reel having a special symbol, and the special symbols including a first special symbol and a second special symbol; and a control unit connected to the control panel and the display unit that spins and stops the plurality of reels in response to a player operating the control panel, and that awards a prize for the arrangement of symbols formed in the symbol display area by the plurality of reels that have been stopped, wherein the control unit in response to a special symbol stopping on the special reel among the plurality of reels spinning in the symbol display area, duplicates and displays a first number of additional symbol display ranges for each of the plurality of reels when the first special symbol stops, and duplicates and displays a second number of additional symbol display ranges for each of the plurality of reels when the second special symbol stops, stops the reels spinning in the symbol display area and the additional symbol display ranges, and awards a prize for the arrangement of symbols formed by the plurality of stopped reels.

Still another aspect of the present disclosure is a method for providing a game executed by a gaming machine comprising: a control panel that accepts player operations; a display unit having a first symbol display area that partially displays a plurality of reels each having symbols, the plurality of reels including a special reel having a special symbol; and a control unit connected to the control panel and the display unit that spins and stops the plurality of reels in response to a player operating the control panel, and that provides a game that awards a prize for the arrangement of symbols formed in the first symbol display area by the plurality of reels that have been stopped, wherein the control unit executes the steps of: stopping the special reel first among the plurality of reels spun in the first symbol display area; further displaying, in response to a special symbol stopping on the special reel, a second symbol display area that duplicates the special reel that has been stopped in the first symbol display area and the reels that are spinning; stopping reels that are spinning in the first symbol display area and the second symbol display area; and providing a first game feature that awards a prize for the arrangement of symbols formed in the first symbol display area and the second symbol display area.

Yet another aspect of the present disclosure is a method for providing a game executed by a gaming machine comprising: a control panel that accepts player operations; a display unit having a symbol display area that partially displays a plurality of reels each having symbols, the plurality of reels including a special reel having a special symbol, and the special symbols including a first special symbol and a second special symbol; and a control unit connected to the control panel and the display unit that spins and stops the plurality of reels in response to a player operating the control panel, and that awards a prize for the arrangement of symbols formed in the symbol display area by the plurality of reels that have been stopped, wherein the control unit executes the steps of: duplicating and displaying a first number of additional symbol display ranges for each of the plurality of reels when the first special symbol stops, and duplicating and displaying a second number of additional symbol display ranges for each of the plurality of reels when the second special symbol stops in response to a special symbol stopping on the special reel among the plurality of reels spinning in the symbol display area; stopping the reels spinning in the symbol display area and the additional symbol display ranges; and awarding a prize for the arrangement of symbols formed by the plurality of stopped reels.

Yet another aspect of the present disclosure is a program executed by a control unit in a gaming machine comprising: a control panel that accepts player operations; a display unit having a first symbol display area that partially displays a plurality of reels each having symbols, the plurality of reels including a special reel having a special symbol; and a control unit connected to the control panel and the display unit that spins and stops the plurality of reels in response to a player operating the control panel, and that provides a game that awards a prize for the arrangement of symbols formed in the first symbol display area by the plurality of reels that have been stopped, wherein the program executes in the control unit the functions of: stopping the special reel first among the plurality of reels spun in the first symbol display area; further displaying, in response to a special symbol stopping on the special reel, a second symbol display area that duplicates the special reel that has been stopped in the first symbol display area and the reels that are spinning; stopping reels that are spinning in the first symbol display area and the second symbol display area; and providing a first game feature that awards a prize for the arrangement of symbols formed in the first symbol display area and the second symbol display area.

Yet another aspect of the present disclosure is a program executed by a control unit in a gaming machine comprising: a control panel that accepts player operations; a display unit having a symbol display area that partially displays a plurality of reels each having symbols, the plurality of reels including a special reel having a special symbol, and the special symbols including a first special symbol and a second special symbol; and a control unit connected to the control panel and the display unit that spins and stops the plurality of reels in response to a player operating the control panel, and that awards a prize for the arrangement of symbols formed in the symbol display area by the plurality of reels that have been stopped, wherein the program executes in the control unit the functions of: duplicating and displaying a first number of additional symbol display ranges for each of the plurality of reels when the first special symbol stops, and duplicating and displaying a second number of additional symbol display ranges for each of the plurality of reels when the second special symbol stops in response to a special symbol stopping on the special reel among the plurality of reels spinning in the symbol display area; stopping the reels spinning in the symbol display area and the additional symbol display ranges; and awarding a prize for the arrangement of symbols formed by the plurality of stopped reels.

In yet another aspect of the present invention, a gaming machine is provided. The gaming machine includes a control panel that accepts player operations, a display unit including a display screen displaying computer-generated images thereon, and a control unit operably coupled to the control panel and the display unit. The control unit including one or more processors programmed to execute an algorithm to display an animated sequence of computer-generated images on the display unit including the steps of: displaying a first symbol display area on the display screen that partially displays a plurality of reels each having symbols, the plurality of reels including a special reel having a first special symbol and a second special symbol; spinning the plurality of reels in response to a player operating the control panel; stopping the special reel first among the plurality of reels spun in the first symbol display area; duplicating and displaying a first number of additional symbol display ranges for each of the plurality of reels when the first special symbol stops on the special reel; and duplicating and displaying a second number of additional symbol display ranges for each of the plurality of reels when the second special symbol stops on the special reel.

In yet another aspect of the present invention, a method of operating a gaming machine is provided. The gaming machine includes a control panel that accepts player operations, a display unit including a display screen displaying computer-generated images thereon, and a control unit including one or more processors operably coupled to the control panel and the display unit. The method includes the one or more processors performing an algorithm to display an animated sequence of computer-generated images on the display unit including the steps of: displaying a first symbol display area on the display screen that partially displays a plurality of reels each having symbols, the plurality of reels including a special reel having a first special symbol and a second special symbol; spinning the plurality of reels in response to a player operating the control panel; stopping the special reel first among the plurality of reels spun in the first symbol display area; duplicating and displaying a first number of additional symbol display ranges for each of the plurality of reels when the first special symbol stops on the special reel; and duplicating and displaying a second number of additional symbol display ranges for each of the plurality of reels when the second special symbol stops on the special reel.

In yet another aspect of the present invention, a non-transitory computer-readable storage media having computer-executable instructions embodied thereon to operate a gaming machine is provided. The gaming machine includes a control panel that accepts player operations, a display unit including a display screen displaying computer-generated images thereon, and a control unit including one or more processors operably coupled to the control panel and the display unit. When executed by the one or more processors the computer-executable instructions cause the one or more processors to perform an algorithm to render an animated sequence of computer-generated images on the display unit including the steps of: displaying a first symbol display area on the display screen that partially displays a plurality of reels each having symbols, the plurality of reels including a special reel having a first special symbol and a second special symbol; spinning the plurality of reels in response to a player operating the control panel; stopping the special reel first among the plurality of reels spun in the first symbol display area; duplicating and displaying a first number of additional symbol display ranges for each of the plurality of reels when the first special symbol stops on the special reel; and duplicating and displaying a second number of additional symbol display ranges for each of the plurality of reels when the second special symbol stops on the special reel.

The present disclosure provides a gaming machine, a method for providing a game, and a program that can provide a feature game with a new twist that sustains and increases player interest. This feature game can provide players with a sense of anticipation and value that exceeds the sum of games simultaneously on offer at a fast pace and without pause.

### BRIEF DESCRIPTION OF DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a perspective view showing an example of a gaming machine in an embodiment of the present disclosure;

FIG. 2 is a block diagram showing an example of the configuration of the gaming machine in FIG. 1;

FIG. 3 is a simplified diagram of the display area in the gaming machine shown in FIG. 1;

FIG. 4 shows an example of a virtual reel set;

FIG. 5 shows examples of symbols;

FIGS. 6-9 shows an example of the animated sequences of computer-generated images of game screens illustrating an algorithm for displaying a first game feature with an additional display area on the gaming machine shown in FIG. 1, according to an embodiment of the present invention;

FIGS. 10-18 shows an example of the animated sequences of computer-generated images of game screens illustrating an algorithm for displaying a second game feature with two additional display areas on the gaming machine shown in FIG. 1, according to an embodiment of the present invention;

FIG. 19 is a directory structure diagram and block diagram showing a program and data stored in the memory in FIG. 2;

FIG. 20 is a block diagram of a system for a gaming machine;

FIG. 21 is a block diagram of the game application program in FIG. 20;

FIG. 22 is a block diagram of the system application program in FIG. 20; and

FIGS. 23-25 are flow charts illustrating algorithms used during operation of the gaming machine to generate and display animated sequences of computer-generated images shown in FIGS. 6-18 to display game features on the gaming machine shown in FIG. 1, according to one embodiment of the present invention.

Corresponding reference characters indicate corresponding parts throughout the drawings.

### DETAILED DESCRIPTION OF THE INVENTION

A gaming machine in an embodiment of the disclosure will now be described with reference to the appended drawings. The same or equivalent elements in each drawing are denoted by the same reference numbers, and redundant descriptions of these elements have been omitted.

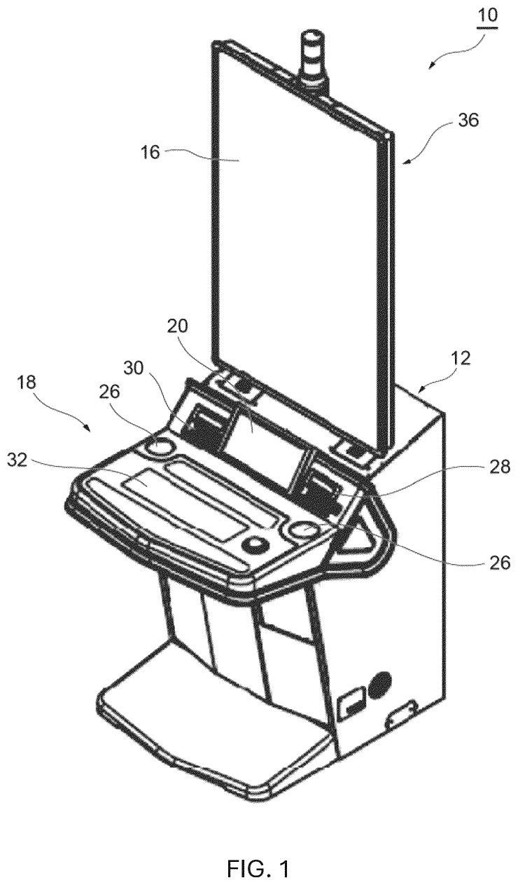

FIG. 1 is a perspective view showing an example of a gaming machine in an embodiment of the present disclosure. A gaming machine is a device that accepts wagers from players, such as banknote, medallions, and tokens to start a game, and then pays out winnings, prizes, and payouts to players according to randomly determined game results. Gaming machines are designed and manufactured in accordance with local regulations, and are installed in licensed facilities such as casinos after being approved by an authorizing organization as an authorized device. The gaming machine 10 shown in FIG. 1 can accept a predetermined game price from a player, generate a game result, and provide a payout to the player according to the game result and a payout table. A gaming machine 10 can provide, for example, a video slot game. Video slot games include regular games, free games, and feature games. Regular games, free games, and feature games are provided when predetermined conditions are met. In regular games, free games and feature games, symbols displayed in a display area make up symbol combinations that are the game results, and these combinations are used to determine prizes.

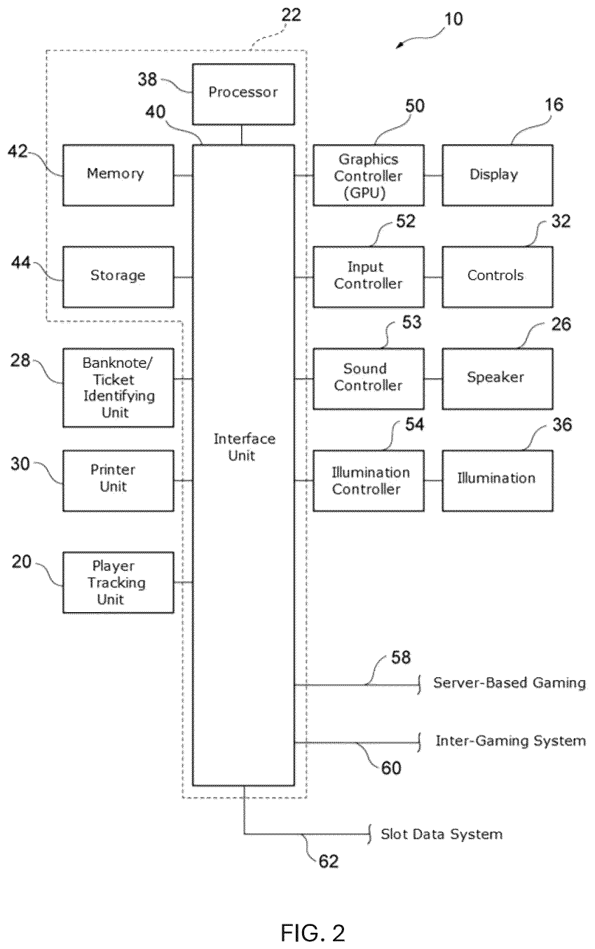

As shown in FIG. 1, the gaming machine 10 has a display 16 (an example of a display unit) and a cabinet 12. The cabinet 12 also contains a control unit 22 (see FIG. 2) that controls the components in the gaming machine 10.

The display 16 is a flat panel display device such as an LCD or OLED display device. The display 16 presents a game screen to the player controlled by the control unit 22. Illumination 36 may be installed around display 16 to provide decorative lighting.

The cabinet 12 is located below the display 16. The cabinet 12 has a control panel 18 that protrudes forward from the front of the cabinet. The control panel 18 is provided with a player tracking unit 20, speakers 26, a banknote/ticket identifying unit 28, a printer unit 30, and controls 32.

The player tracking unit 20 includes a card reader that recognizes player identification cards, a display that presents data to players, and a keypad that accepts player input. The player tracking unit 20 working in tandem with the control unit 22 or an external system reads information recorded on a player identification card inserted into the card reader by a player, and displays this information and/or information obtained via communication with an external system on the display. Keypad input from the player is also accepted, the display is changed according to the input, and communication with an external system is performed as necessary.

Speakers 26 are provided on the left and right of the control panel 18. The speakers 26 are controlled by the control unit 22 to provide sound for the player.

The banknote/ticket identifying unit 28 can be housed in the cabinet 12 with an exposed insertion slot for inserting banknotes or tickets. There is a sensor inside the slot to identify banknotes and tickets. A banknote/ticket storage unit is provided on the output end of the identifying unit. The banknote/ticket identifying unit 28 accepts banknotes or tickets (including vouchers and coupons) with game value, identifies them as having a certain game value, and notifies the control unit 22.

A printer unit 30 can be housed inside the cabinet 12 with an exposed ticket discharge slot for discharging tickets. A printing unit for printing specific information on a slip of paper inside the ticket discharge slot. A storage unit that holds the paper is provided on the paper input end of the printing unit. The printer unit 30 prints information on paper under the control of the control unit 22, and outputs tickets from the gaming machine 10 according to a credit payout process. A ticket that has been outputted can be inserted into the banknote/ticket identifying unit 28 of another gaming machine to use paid-out credits for game play, or it can be exchanged for cash at a kiosk terminal or casino cage in the casino.

The controls 32 are used to accept player input. The controls 32 include a group of buttons used to accept various instructions from a player in front of the gaming machine 10. For example, the controls 32 may include a group of spinning buttons and setting buttons. The spinning buttons accept instructions to start a game session (start the reels spinning). The group of setting buttons includes, for example, bet-placing buttons and a cash-out button. The group of betting buttons are used to accept instructions from the player regarding the amount of credit to be bet (bet amount). The cash-out button is used to accept an instruction to cash out credits accumulated in the gaming machine 10.

FIG. 2 is a block diagram showing an example of a configuration for a gaming machine. The gaming machine 10 includes a control unit 22. The control unit 22 includes a CPU (Central Processing Unit) 38, including one or more processors that constitutes the control unit 22, an interface unit 40, memory 42, and storage 44, etc. The control unit 22 can be housed inside the cabinet 12 as a control board. The control unit 22 is configured to be able to communicate with each component via an interface unit 40, and controls the operation of each component by executing a program recorded in the memory 42 (an example of a storage unit) or the storage 44 (an example of a storage unit) for the CPU 38 in order to provide the game to the player.

The interface unit 40 includes a chipset that provides the communication functions of the CPU 38, such as a memory bus connected to the CPU 38, expansion buses, a serial interface, a USB (Universal Serial Bus) interface, and an Ethernet (registered trademark) interface.

The memory 42 can be configured to include a volatile memory medium such as RAM (Random Access Memory), a non-volatile memory medium such as ROM (Read-Only Memory), and a rewritable non-volatile memory medium such as EEPROM (Electrically Erasable Programmable Read-Only Memory). The storage 44 provides the control unit 22 with the functions of an external storage device, and makes it possible to use removable storage media such as a memory card or optical disk, in addition to a hard disk.

The interface unit 40 is connected to the banknote/ticket identifying unit 28, the printer unit 30, the player tracking unit 20, a graphics controller (GPU: Graphics Processing Unit) 50, an input controller 52, a sound controller 53, and an illumination controller 54. The graphics controller 50, input controller 52, sound controller 53, and illumination controller 54 can be housed inside the cabinet 12 as a control board.

The control unit 22 is connected to the display 16 via the graphics controller 50. The control unit 22 is connected to the controls 32 via the input controller 52. The control unit 22 is connected to the illumination 36 via the illumination controller 54.

The control unit 22 controls each component by executing a program stored in the memory 42 and the storage 44 to provide the game to the player. For example, here, the operating system, subsystem programs, and data that provide the basic functions of the control unit 22 may be stored in EEPROM inside the memory 42, and the program and application data that provide the game may be stored in the storage 44. By using this configuration, the game can be easily changed or updated by replacing the storage 44. The control unit 22 may also be configured with a multiprocessor configuration including a plurality of CPUs.

Each block connected to the control unit 22 will now be described. The banknote/ticket identifying unit 28 accepts a banknote or ticket at the insertion slot and notifies the control unit 22 of identifying information corresponding to the type of banknote or credit payout process. The control unit 22 increases the amount of credit available in the game based on the details. The printer unit 30 accepts activation of the cash-out button in the control unit 32, and prints information corresponding to the credit payout process from the gaming machine 10 under the control of the control unit 22 on a ticket, which is then outputted.

The player tracking unit 20 operates in tandem with the control unit 22 to exchange player information and other information with the casino management system. The graphics controller 50, under the control of the control unit 22, displays images containing various graphics data on the display 16. The sound controller 53 drives the speakers 26 under the control of control unit 22 to provide various sounds such as announcements, sound effects, and background music. The illumination controller 54 performs lighting control of the illumination 36 under the control of control unit 22.

The interface unit 40 includes various communication interfaces for communicating with devices outside of the gaming machine 10. The interface unit 40 can communicate with external networks, for example, by means of Ethernet 55, 58, 60, and a serial interface 62. Examples of communication with other gaming machines 10 using a known server-end gaming network (server-based gaming), G2S network (game-to-system), and slot information system (slot data system) are shown in FIG. 2. The control unit 22 can share information about games with other gaming machines 10 by communicating with the control unit 22 in other gaming machines 10 via Ethernet 55, 58, 60 without an I/O board.

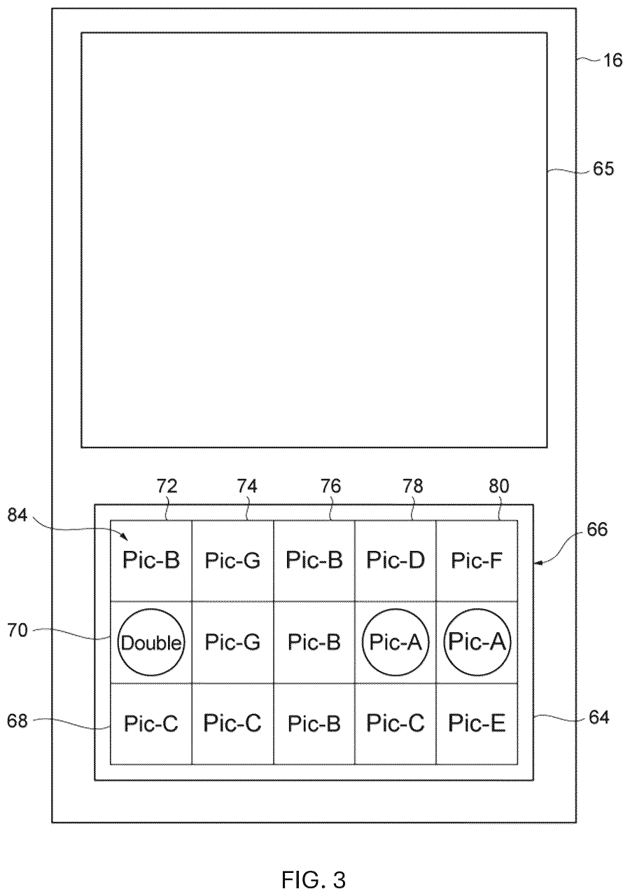

FIG. 3 is a simplified diagram of the display area in the gaming machine shown in FIG. 1. As shown in FIG. 3, the control unit 22 executing the predetermined program causes the display 16 to show a game screen of a slot game with a first symbol display area 64. The first symbol display area 64 partially displays a plurality of reels, each with symbols. The symbol display area 64 can be displayed, for example, in the lower area of the game screen. An area 65 is provided above the symbol display area 64 for displaying game-related information and other information.

The first symbol display area 64 includes a grid 68 on which symbols can be displayed. By using such a display area, a gaming machine 10 can operate as a slot machine that determines prizes and pays out prizes according to the combinations of symbols displayed on the grid 68 in symbol display region 64.

The display 16 displays a plurality of symbols in the grid 68. The grid 68 contains a plurality of rows and columns. The grid 68 is composed of a plurality of cells 70, which are the stopping positions of the symbols. FIG. 3 shows a game screen containing a plurality of cells arranged in a 5×3 grid. The number of columns and rows in the grid is not limited, and other configurations may be used, such as 5×4, 3-4-4-4-3, 6×3, 6×4, and 3-3-3-5-5, etc. In addition, the configuration increases or decreases the grid depending on the game progress and/or the bet amount. Each cell 70 in the first symbol display area 64 displays a stopped symbol.

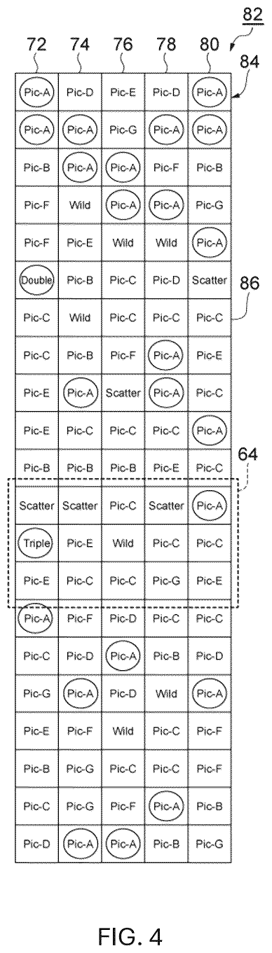

The symbols arranged in each of the cells 70 are determined by virtual reel strips displaying virtual reels 66. FIG. 4 shows an example of a virtual reel set. The virtual reel set includes a plurality of virtual reel strips, and virtual reel strips include an arrangement of symbols that indicates the order of the symbols displayed in the display area. In each cell 70 of the grid 68 shown in FIG. 4, symbols are displayed based on the arrangement of symbols on the virtual reels 66, which include virtual reel strips 72, 74, 76, 78, and 80 that make up the virtual reel set 82. In other words, the cells 70 in grid 68 correspond to virtual reel strips 72 to 80 in each column, and the symbols arranged in certain portions of virtual reel strips 72 to 80 are displayed. The symbols displayed in the cells 70 of the grid 68 are changed by moving (scrolling or spinning) the symbols in each column based on the arrangement of symbols on virtual reel strip 72 to 80, and the symbols are stopped by stopping the movement (scrolling or spinning) in each column. Here, virtual reel strips 72 to 80 consist of data, and the control unit 22 uses a program in the memory 42 or storage 44 and this data to display the arrangement of symbols (that is, the order of the symbols on each reel strip) adjusted in each cell column. Virtual reel set 82 is a collective term for the virtual reel strips 72-80.

The virtual reel strips 72-80 shown in FIG. 4 are composed of symbols 84 at each symbol position 86, and these symbols are arranged in the order defined for each reel. The number of symbols constituting the virtual reel strips 72-80 is not limited, and can be any number desired. In addition, the number of symbols that constitute each of virtual reel strips 72 to 80 may be the same or different.

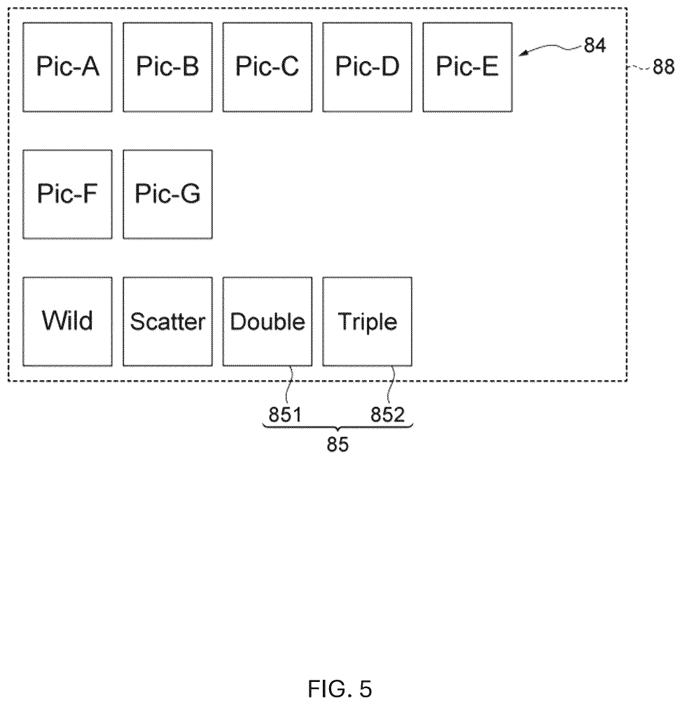

FIG. 5 is used to explain details of the symbols 84 shown in FIG. 4. Each virtual reel strip 72-80 contains symbols selected from the set 88 of symbols 84 shown in FIG. 5. The symbol set 88 includes picture symbols (Pic-A, Pic-B, Pic-C, Pic-D, Pic-E, Pic-F, and Pic-G) that indicate pictures of people, animals, plants, objects, and treasures, etc. Picture symbols may be awarded multipliers that increase the award amount of a combination by a predetermined multiple.

The symbol set 88 includes a wild symbol (“Wild”) that is substituted for another symbol when determining winning combinations, a scatter symbol (“Scatter”) that triggers a free game when a predetermined number occurs when determining winning combinations, and special symbols 85 that serve as a trigger for game features. These special symbols 85 include the first special symbol 851 (“Double”) and a second special symbol 852 (“Triple”). When the first special symbol 851 is displayed, a first game feature with an additional display area is provided, resulting in two display areas. When the second special symbol 852 is displayed, a second game feature with two additional display areas is provided, resulting in three display areas. A special symbol 85 is included on the first reel to stop (virtual reel strip 72 in the example shown in FIG. 4).

The symbol set 88 may include symbols that win a progressive jackpot (not shown). The symbol set 88 can, for example, contain symbols that increase the amount won in the order “Mini”, “Major”, and “Grand”. These symbols award winning amounts simply by stopping.

A plurality of virtual reel sets may be provided depending on the content of the game. For example, the virtual reel set used in regular games may be separate from those used in free games and feature games. The virtual reel set during free games or feature games may be configured to contain more special symbols 85 or wild symbols than the virtual reel set during regular games. In this way, the probability or expectation of winning a prize during free games can be increased, providing players with a highly valuable free game.

The control unit 22 starts a game and randomly determines the stopping positions of each virtual reel strip 72-80. The virtual reel strips 72-80 displayed on the display 16 start moving (scrolling or spinning) from the current position, stop based on the stop positions, and indicate the result of the game. As a result, in the display 16 or grid 68, the symbols on the virtual reel strips 72-80 change with the continuous vertical movement (scrolling or spinning) of the virtual reel strips 72-80 in the first symbol display area 64, and symbols stop in each cell 70 according to the order of the symbols specified on the virtual reel strips 72-80.

The control unit can be configured so that the symbols displayed on the display 16 change according to the method described above, according to a player operation accepted using the controls 32, the symbols are stopped in a predetermined order, and a payout is made according to the symbols that have stopped in the first symbol display area 64.

The first symbol display area 64 is set up with pay lines. Pay lines are set up, for example, to span from the left-most column of cells to the right-most column. For example, the pay line can consist of any cell in the left-most column, any cell in the second column from the left, any cell in the third column from the left, any cell in the fourth column from the left, and any cell in the fifth column from the left (the right-most column). The 5×3 matrix allows for 243 different pay lines (3 to the power of 5), of which 40 or 50 may be set. In the so-called all-ways-win (ALL-WAYS-WIN) system, all 243 pay lines are set to award a prize. These pay lines may be configured to be activated as winning lines when selected by the player. A winning line is a pay line which has won. The number of winning lines can be selected when the player operates a group of line setting buttons in the group of setting buttons in the controls 32. The system may also be configured to use all of the set pay lines as winning lines, regardless of player selection. The control unit 22 determines that a prize is to be awarded when more than a predetermined number of identical symbols are arranged on a winning line with respect to the outcome of the game, which is a combination of symbols, and makes a payout to the player according to the type and number of symbols.

The gaming machine 10 in the present embodiment provides three types of games: a regular game (also referred to as the main game or primary game) that is provided when predetermined conditions are not met, and a first special game and a second special game that are provided when predetermined conditions are met. The first special game is a feature game, and a feature function described below, which is advantageous to the player, is applied when the predetermined trigger conditions are met. The second special game is a free game, and a predetermined number of free games are provided that do not consume game tokens or credit when predetermined trigger conditions are met.

For example, the gaming machine 10 may include computer-executable instructions including algorithms for providing the Fortune Mint™ Trinity™ slot game series offered by Konami Gaming™ Inc.

In the regular game, the first special game, and the second special game described above, the arrangement of symbols is used to award a prize. In other words, the control unit 22 that has started a game randomly determines the stopping positions for each of the virtual reel strips 72-80 shown in FIG. 4, and uses the display 16 to represent the movement of the virtual reel strips 72-80 from their current positions to their stopping positions. This causes the symbols arranged on the virtual reel strips 72-80 to move (scroll) continuously in the vertical direction in the first symbol display area 64 and then stop so that a single symbol appears in each cell 70 while maintaining a sense of continuity.

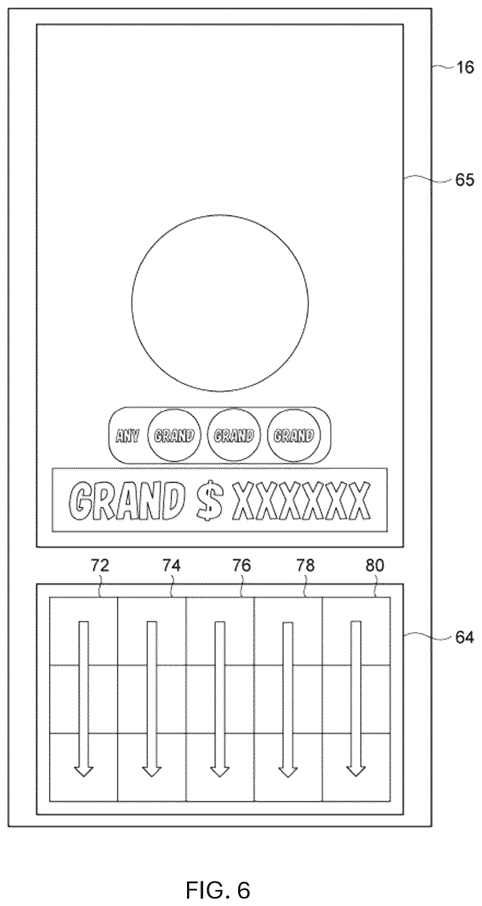

However, in the present embodiment, when a special symbol 85 stops on the first reel that is stopped in the regular game or the second special game, which is a free game, the game becomes a feature game, and the feature function described below is triggered, resulting in an additional symbol display area. The feature function is explained below with reference to FIG. 6 to FIG. 18. The reels displayed in the first symbol display area 64 are referred to below, from left to right, as the first reel, second reel, third reel, fourth reel, and fifth reel. Only the first reel includes a special symbol 85. The column formed by the first reel in the display area of the display 16 is referred to as the first column. Similarly, the column related to the second reel is referred to as the second column, the column related to the third reel as the third column, the column related to the fourth reel as the fourth column, and the column related to the fifth reel as the fifth column.

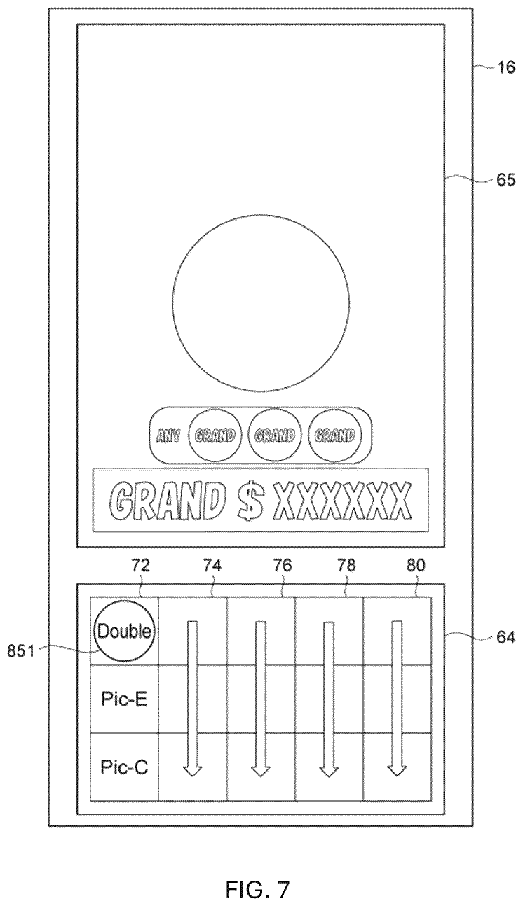

As shown in FIG. 6, the control unit 22 spins and sequentially stops the reels corresponding to virtual reel strips 72 to 80. First, as shown in FIG. 7, the control unit 22 stops the spinning first reel (virtual reel strip 72), where the first special symbol 851 (“Double”) is displayed in the first column of the first symbol display area 64. Thus, the game will transition to a feature game and a feature function is triggered when the first stopped reel (special reel) stops on the special symbol 85. Here, it has stopped on the first special symbol 851, so the first game feature is offered.

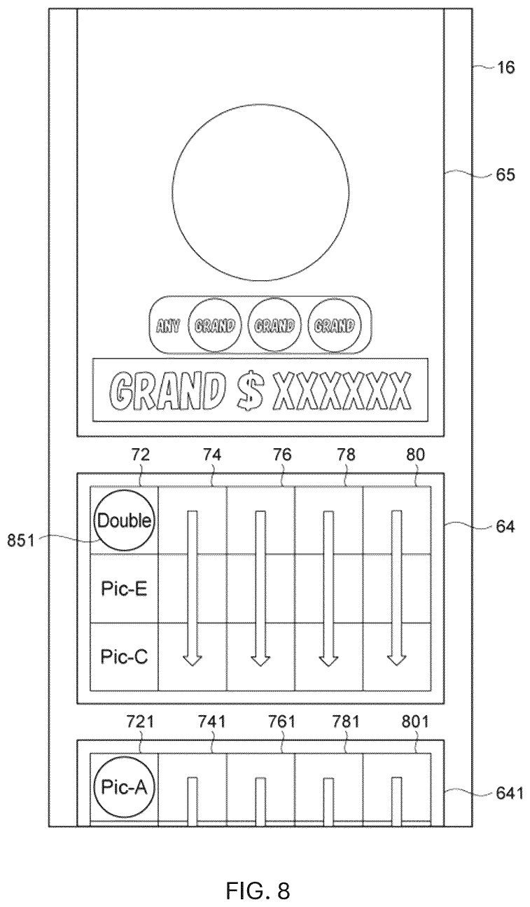

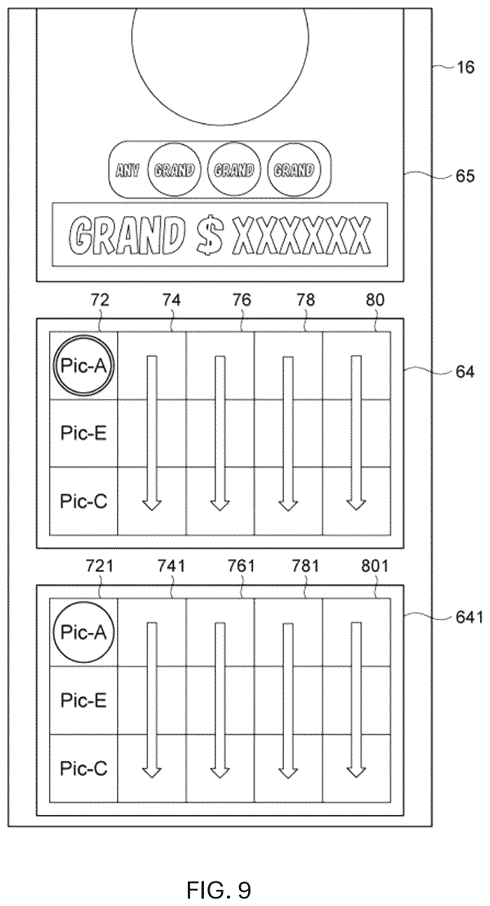

As shown in FIG. 8, when the first game feature is started, the area 65 that displays information about the game and the first symbol display area 64 that includes the spinning reels move upward on the screen, and a second symbol display area 641 is added to the screen below the first symbol display area 64. The entire second symbol display area 641 is then displayed as shown in FIG. 9.

In the second symbol display area 641, the first reel that has stopped in the first symbol display area 64 is duplicated and displayed with the second, third, fourth and fifth reels spinning in the first symbol display area 64. Before the spinning reels in the first symbol display area 64 and second symbol display area 641 have been stopped, the first special symbol 851 displayed in the first symbol display area 64 and the second symbol display area 641 is converted into a symbol that is eligible for a prize. In the example shown in FIG. 9, the first special symbol 851 (“Double”) is converted to Pic-A. The conversion of symbols in the second symbol display area 641 may be performed when the first reel that has stopped in the first symbol display area 64 is duplicated, as shown in FIG. 8.

The reels spinning in the first symbol display area 64 and second symbol display area 641 shown in FIG. 9 are then sequentially stopped to form arrangements of symbols. In the first game feature, a prize is determined and awarded for each of the arrangement of symbols formed in the first symbol display area 64 and the second symbol display area 641. Thus, not only does the possibility of winning a prize increase with the addition of the second symbol display area 641, which is a duplicate of the first symbol display area 64 in the ongoing game, but the first special symbol 851 is converted into a symbol that is eligible for a prize, thereby duplicating a potentially prize-winning arrangement of symbols. Therefore, a more lucrative feature game can be provided with a higher sense of anticipation and expectation than simply playing the regular game twice, which in turn sustains or increases the interest of players.

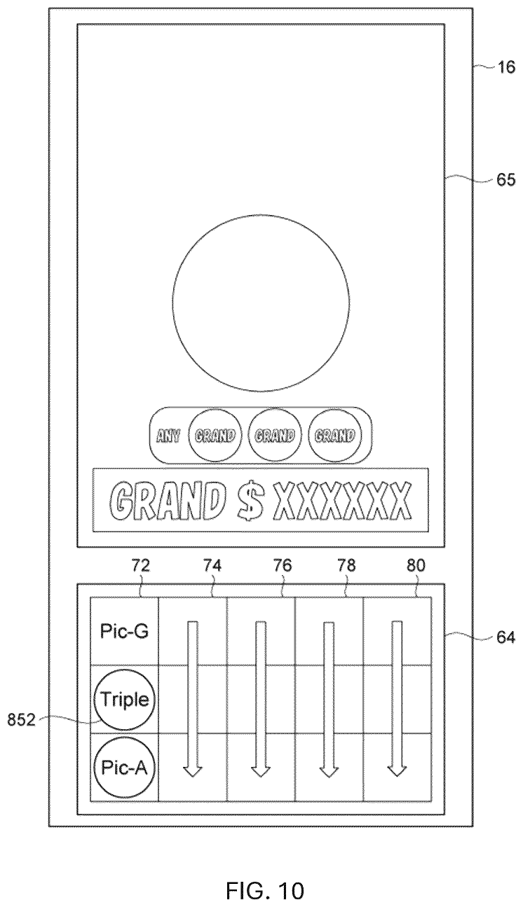

Next, as shown in FIG. 10, the second special symbol 852 (“Triple”) appears in the first column when the spinning first reel (virtual reel strip 72) is stopped. In response to the first reel stopping on a special symbol 85, the game transitions to a feature game and a feature function is activated. Here, it has stopped on the second special symbol 852, so the second game feature is offered.

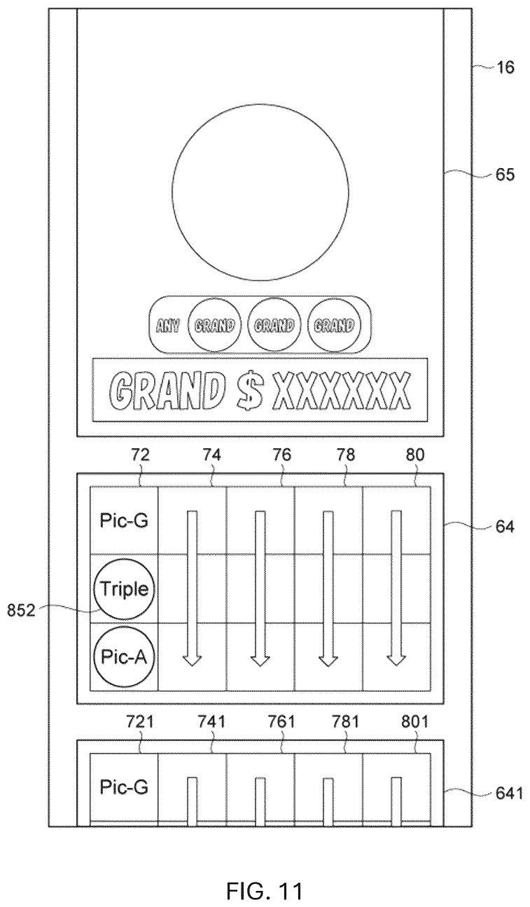

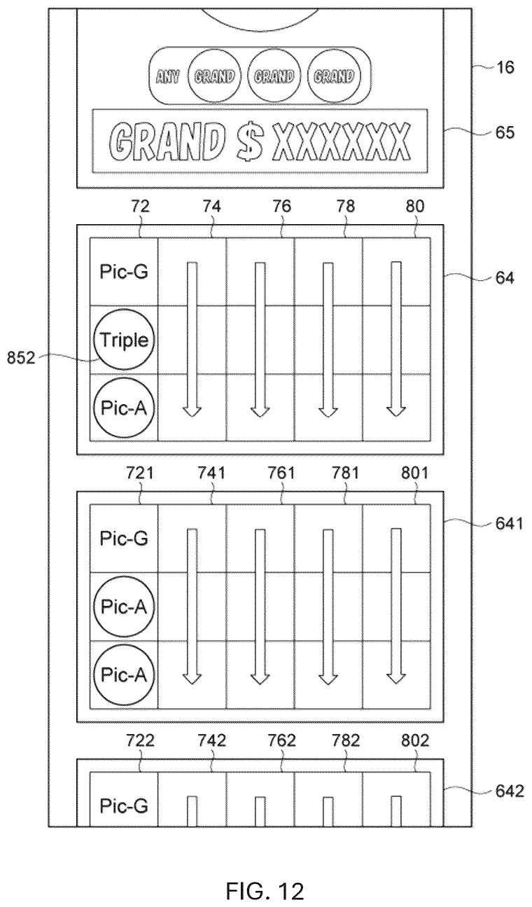

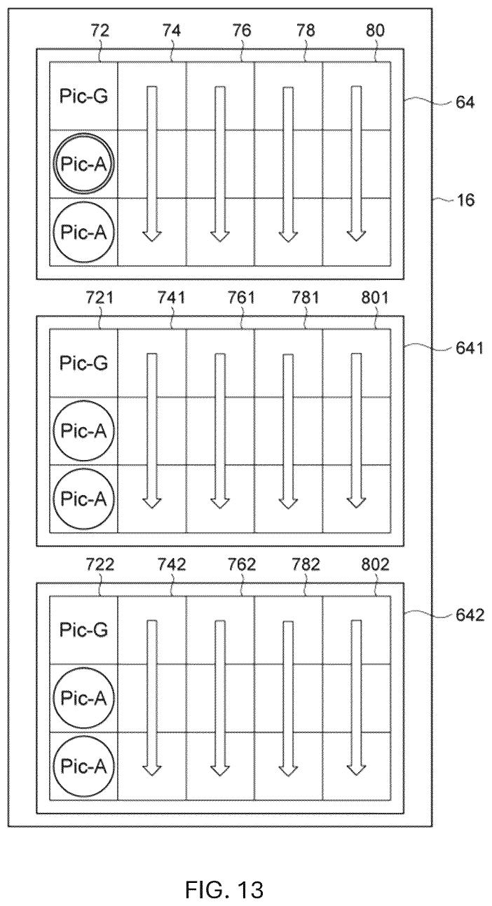

As shown in FIG. 11, when the second game feature is started, the area 65 that displays information about the game, and the first symbol display area 64 that includes the spinning reels move upward on the screen, and a second symbol display area 641 is added to the screen below the first symbol display area 64. As shown in FIG. 12, following the second symbol display area 641, a third symbol display area 642 is also added to the screen. This results in the display of the first symbol display area 64, the second symbol display area 641, and the third symbol display area 642, as shown in FIG. 13.

The first reel stopped in the first symbol display area 64 and the second, third, fourth and fifth reels spinning in the first symbol display area 64 are duplicated in the second symbol display area 641 and third symbol display area 642. Before the spinning reels in the first symbol display area 64, second symbol display area 641, and third symbol display area 642 have been stopped, the second special symbol 852 displayed in the first symbol display area 64, the second symbol display area 641, and the third symbol display area 642 is converted into a symbol that is eligible for a prize. In the example shown in FIG. 13, the second special symbol 852 (“Triple”) is converted to Pic-A. The conversion of symbols in the second symbol display area 641 and the third symbol display area 642 may be performed when the first reel that has stopped in the first symbol display area 64 is duplicated, as shown in FIG. 12.

The reels spinning in the first symbol display area 64, second symbol display area 641, and third symbol display area 642 shown in FIG. 13 are then sequentially stopped, forming arrangements of symbols. In the second game feature, a prize is determined for arrangements of symbols formed in the first symbol display area 64, second symbol display area 641, and third symbol display area 642, and the prize is awarded. Thus, because the second game feature has a larger number of additional display areas than the first game feature, a more lucrative feature game with higher expectations and anticipation than the first game feature is provided, further sustaining or increasing player interest.

The control unit 22 may stop the reels in the next display area after all reels in one display area have been stopped. When a reel displays a symbol that is eligible for a prize in a display area where all the reels have been stopped, the reel on which the symbol has stopped may be duplicated in the corresponding reel in a display area where the reels are to be stopped next.

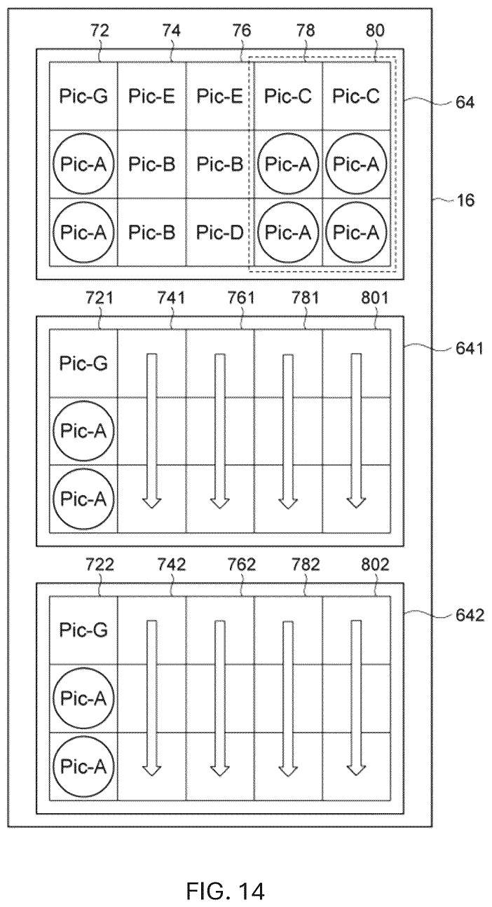

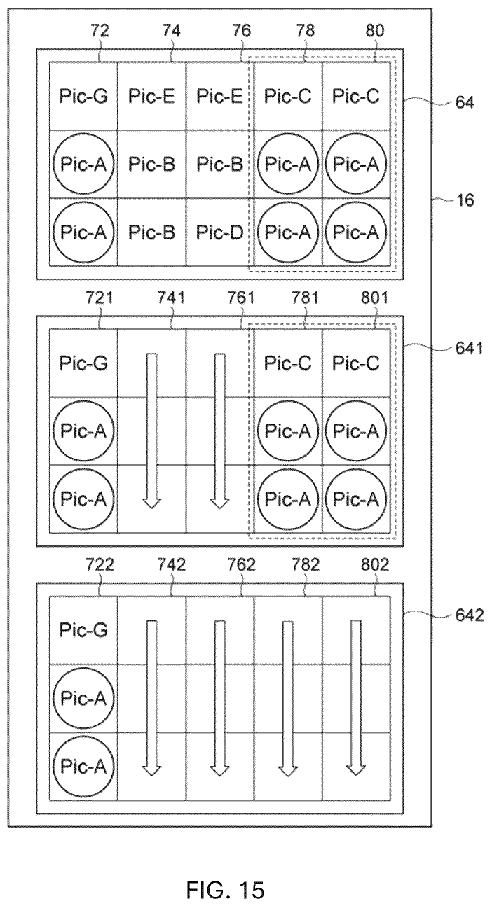

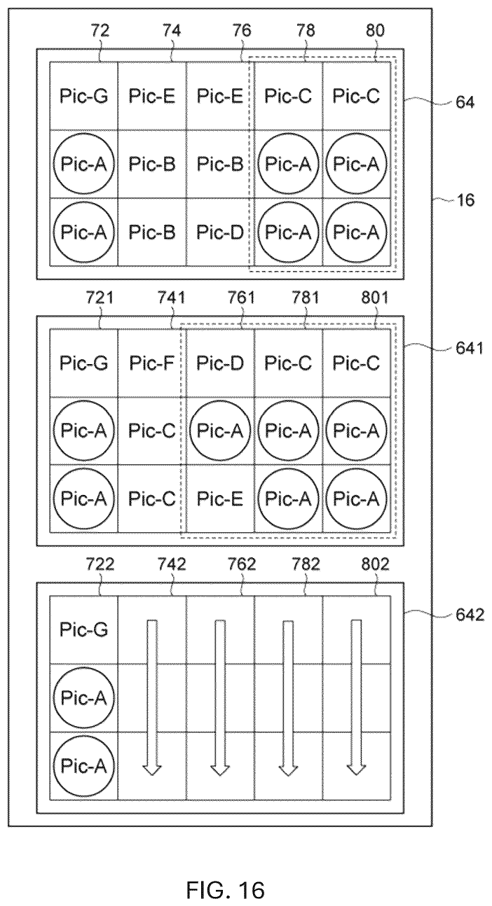

For example, the spinning reels are stopped in successive order in the first symbol display area 64, the second symbol display area 641, and the third symbol display area 642. In this case, from the spinning state shown in FIG. 13, all reels in the first symbol display area 64 are stopped, as shown in FIG. 14. “Pic-A” displayed in the fourth and fifth columns is a symbol that is eligible for a prize, because a prize is awarded when “Pic-A” stops in the second and third columns. A fourth and fifth reel with this symbol are duplicated and displayed in the second symbol display area 641, which is the next to stop spinning, as shown in FIG. 15. As a result, the first, fourth, and fifth reels have already stopped in the second symbol display area 641, and the second and third reels are still spinning. All reels are then stopped in the second symbol display area 641, as shown in FIG. 16. “Pic-A” displayed in the third, fourth and fifth columns are symbols that are eligible for a prize because a prize is awarded when the “Pic-A” stops in the second column.

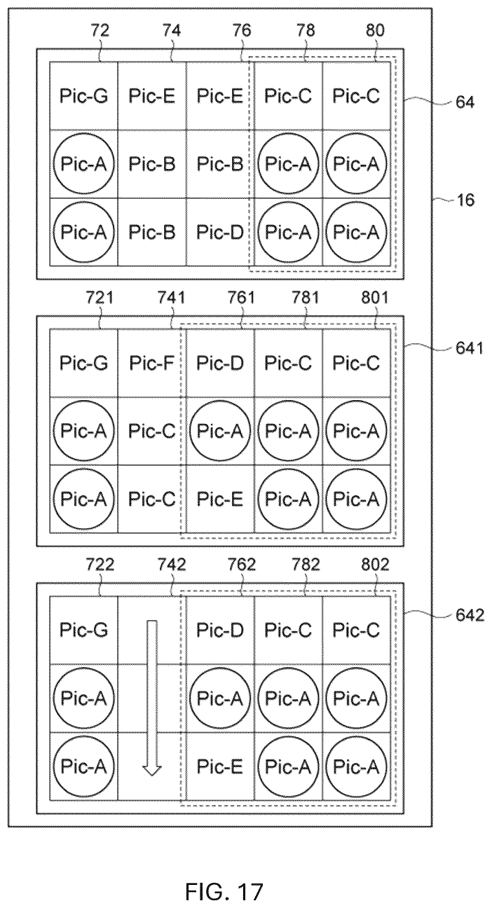

The third, fourth, and fifth reels with these symbols are duplicated and displayed in the third symbol display area 642, which is the next to stop spinning, as shown in FIG. 17. Therefore, in the third symbol display area 642, the first, third, fourth, and fifth reels have already stopped and the second reel is still spinning.

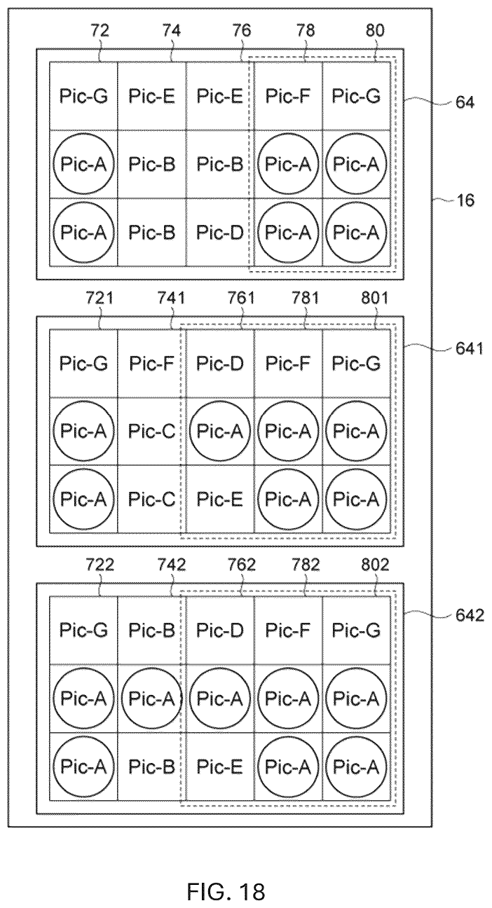

The second reel is then stopped in the third symbol display area 642, as shown in FIG. 18. At this time, “Pic-A” constitutes a winning combination and the player is awarded a prize.

The reel duplication process described above can be applied to the first game feature in addition to the second game feature.

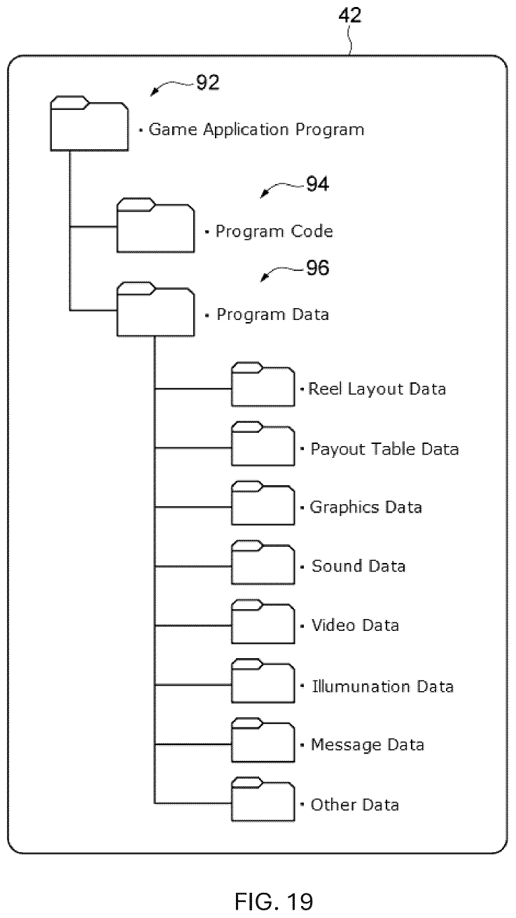

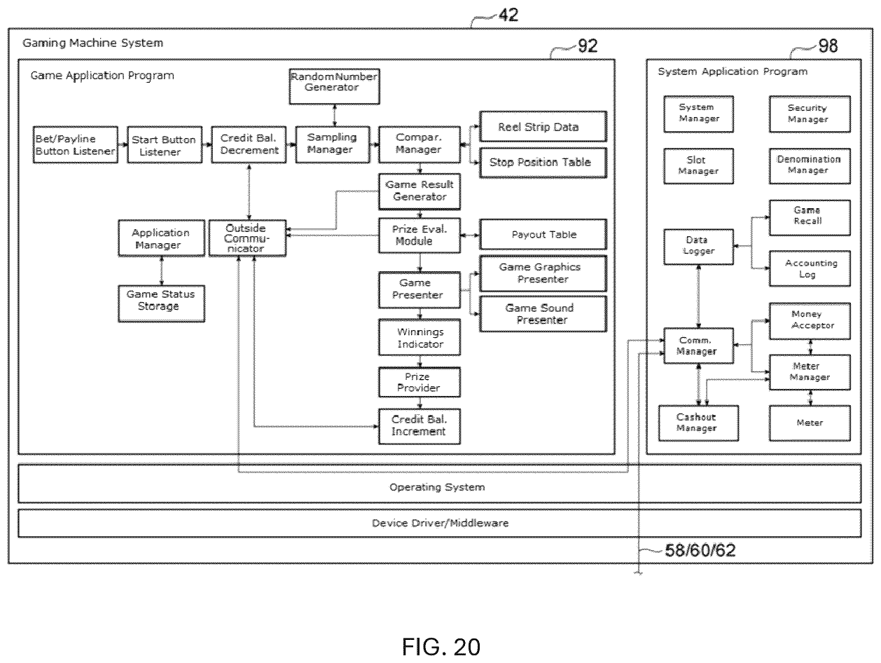

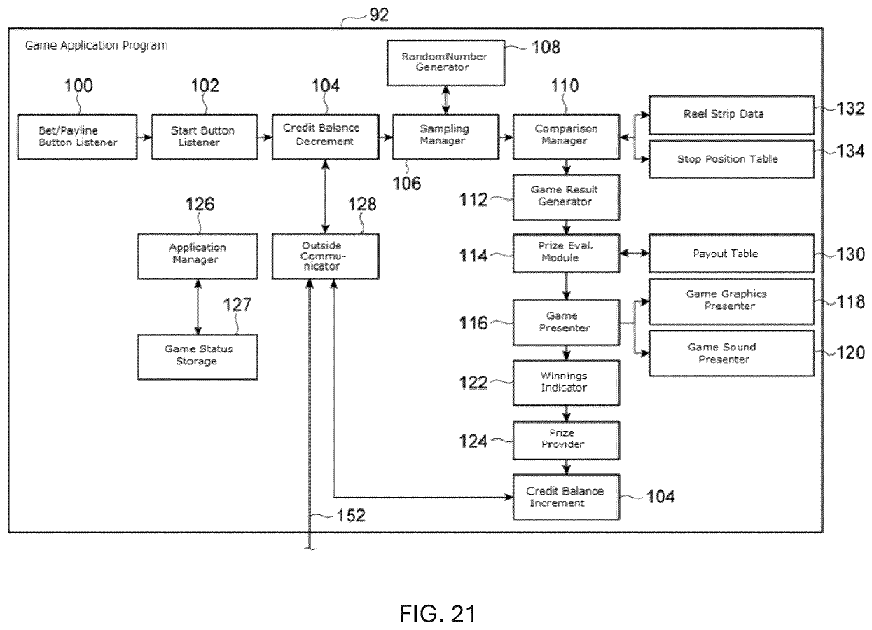

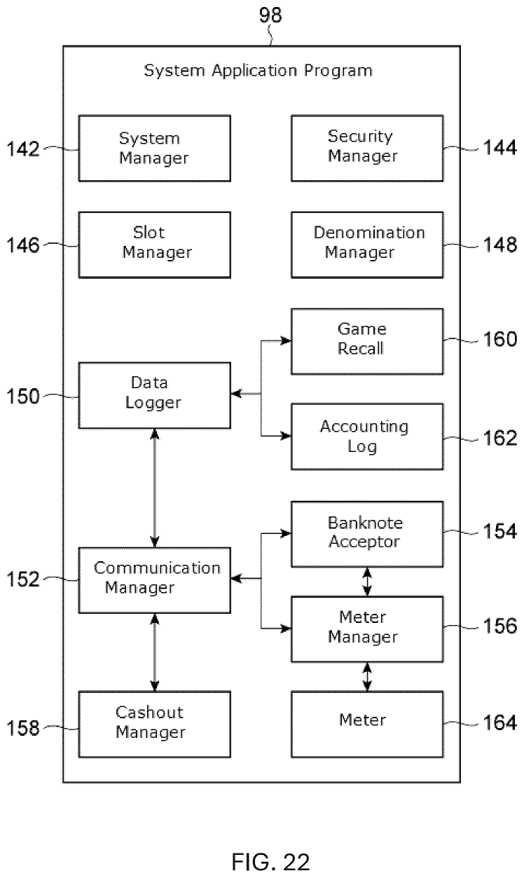

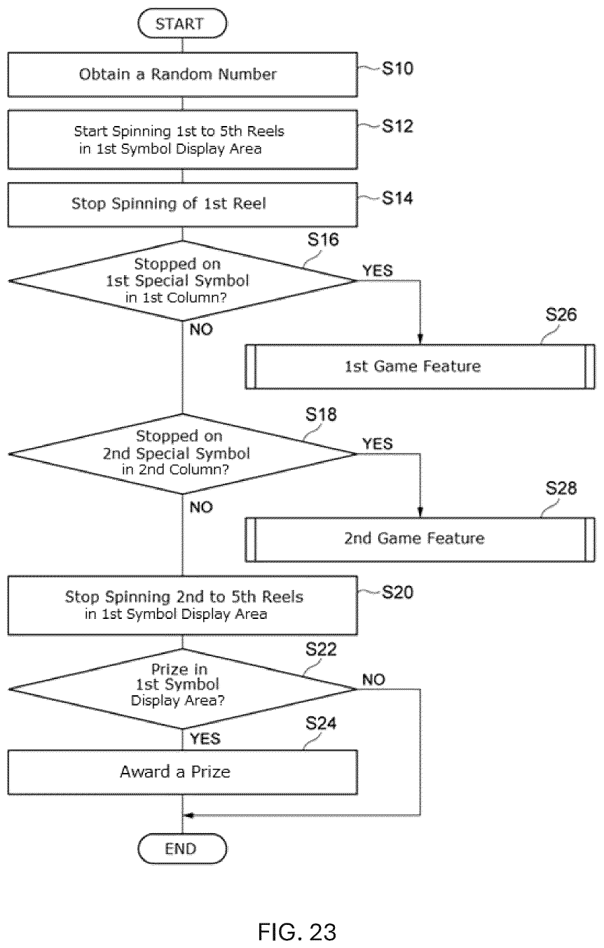

FIG. 19 and FIG. 20 are a directory diagram and block diagram showing the programs and data stored in the memory of FIG. 2. FIG. 21 is a block diagram of the game application program in FIG. 20. FIG. 22 is a block diagram of the system application program in FIG. 20. In the embodiment shown in FIG. 19 to FIG. 22, the memory 42 stores a game application program 92 containing computer-executable instructions, and these computer-executable instructions are executed by the CPU 38 to run the game on the game screen of the display 16 in the gaming machine 10. In one embodiment, the game application program 92 includes program code 94 and program object data 96 containing computer executable instructions for executing a game using the algorithms shown in FIG. 23 to FIG. 25.

In another embodiment, the memory 42 stores a game application program 92 and system application program 98 containing computer executable instructions, and the CPU 38 executes these computer executable instructions to display the game on the game screen of the display 16 in the gaming machine 10. The game application program 92 provides game-specific front-end functionality, while the system application program 98 provides generic back-end functionality when executed by the CPU. In the depicted example, the game application program 92 and the system application program 98 are run on the same operating system. However, these programs may be implemented on different operating systems or on different processors.

In one embodiment, the game application program 92 includes a plurality of software modules, including a bet/pay line button listener module 100, a start button listener module 102, a credit balance manager module 104, a sampling manager 106, a random number generator (RNG) 108, a comparison manager 110, a game result generator 112, a prize evaluating module 114, a game presenter 116, a game graphics presenter 118, a game sound presenter 120, winnings indicator 122, a prize provider 124, an application manager 126, and an outside communicator 128. The game application program 92 can include a payout table 130 (payout table), reel strip data 132, and a stop position table 134.

The bet/pay line button listener module 100 is a software module for accepting signals from bet buttons in the controls 32 or line setting button. These signals are generated by the buttons when the player operates the buttons to select a bet amount or valid number of pay lines. In response to a received signal, the bet/pay line button listener module 100 communicates which signal has been generated to the application manager 126 in order to change the game bet or valid pay lines.

The start button listener module 102 is a software module for accepting signals from the start button. These signals are generated when the player operates this button to start a game. In response to a received signal, the start button listener module 102 communicates that a signal has been generated to the application manager 126 to start the game.

When a signal has been received from the start button listener module 102, the application manager 126 has the sampling manager 106 obtain the required number of random numbers from the random number generator 108.

The random number generator 108 is a software module that generates random numbers based on a predetermined random number generation calculation algorithm. The random number generator 108 may be configured to generate pseudo-random numbers. The random number generator 108 returns random numbers in response to a request from the sampling manager 106. The random number generator 108 may be implemented in whole or in part as an integrated circuit or wired logic.

The comparison manager 110 compares the current state of the game and/or each random number with the reel strip data 132 and the stop position table 134 to specify the corresponding reel strip stop position based on each random number.

The reel strip data 132 has virtual reel strips for regular games, free games, and special games. The comparison manager 110 queries the application manager 126 to identify the current state of the game and select virtual reel strips.

The stop position table 134 contains a range of random numbers associated with each stop position for the virtual reel strips. The comparison manager 110 determines the stop position of each reel based on the corresponding random number and the stop position table 134.

The game result generator 112 generates game results based on the selected reel layout, the stop position of each reel, the stop position of the symbols on the reels, and any additional attributes. In one embodiment, the game result generator 112 may apply changes to game results when predetermined conditions are met.

The prize evaluation module 114 evaluates the game results by referring to the payout table 130. Specifically, prize evaluations are based on whether the symbols defined as winning combinations in the payout table 130 have stopped in the pay lines set as winning lines in the first symbol display area 64.

The game presenter 116 uses the game graphics presenter 118 and the game sound presenter 120 to provide a game presentation process consisting of video and sound to eventually shape a given game outcome.

The game sound presenter 120 uses the sound controller 53 and speakers 26 to provide the sound presentation process. The winnings indicator 122 shows the winning combinations of winning symbols formed in the game results as well as the payout conditions. The prize provider 124 provides credits to a winnings meter based on the winnings evaluation.

The application manager 126 manages the operations and status of each software module. In addition, the application manager 126 manages the configuration, progress, and status of the game application program 92. The application manager 126 references a game status memory 127 to determine the size of the first symbol display area 64 based on the stored game status in order to provide the game. The outside communicator 128 exchanges instructions and data with the system application program 98.

The credit balance manager module 104 executes the process for decrementing the credit balance based on the bet amount and incrementing the credit balance based on the total amount of winnings displayed on the winnings meter. The payout table 130 includes the payout or awarded amount associated with each winning combination.

In one embodiment, the system application program 98 provides functions other than background processing and game-specific functions. The system application program 98 includes a system manager 142, a security manager 144, a slot management module 146, a denomination manager 148, a data logger 150, a communications manager 152, a banknote acceptor manager 154, a meter management module 156, and a cash-out manager 158.

The system application program 98 may include game recall file 160, an accounting log 162, and meters 164. The system manager 142 is a software module for managing all functions other than background processing and game-specific functions performed by the system application program 98.

The security manager 144 is a software module for managing game verification, door security, and monitoring security sensors. The slot management module 146 is a software module for managing data storage and communicating with external slot information systems.

The denomination manager 148 is a software module for configuring the denomination settings of the gaming machine 10. Denomination settings can include 1 cent, 2 cents, 5 cents, 25 cents, 1 dollar, 5 dollars, etc. The data logger 150 is a software module for recording the results of each game in the game recall. In addition, the data logger 150 stores error events, banknote logs, cash-out logs, and ticket logs in the accounting log.

A game recall file 160 is stored data containing the results of each game. The game recall file 160 is stored in nonvolatile memory. The accounting log 162 is stored data that includes error events, banknote logs, cash-out logs, and ticket logs, etc. The accounting log 162 is stored in nonvolatile memory.

The communication manager 152 is a software module that manages communication between the game application program 92 and the system application program 98. The communication manager 152 manages network communications between the system application program 98 and other gaming machines 10, and external networks (such as slot management system networks, G2S networks, gaming servers for server-based gaming networks, and VLT system networks).

The banknote acceptor manager 154 is a software module for managing a banknote acceptor and accepts information on banknotes inserted into the acceptor. In response to information received from the banknote acceptor, the banknote acceptor manager 154 communicates with the meter management module to increment the credit balance based on the inserted bill.

The meter management module 156 is a software module for adjusting the value of the meters 164 in response to communication with the game application program 92 via the communication manager 152, banknote acceptor manager 154, or cash-out manager 158. The meters 164 includes a credit meter that indicates the current credit balance on the gaming machine and a winnings meter that indicates the total amount of winnings in the current gaming session. The meter also includes background meters, such coin-in, coin-out, total drop, jackpots paid by the customer service staff, and/or paper money meters. These meters may be implemented as data on nonvolatile memory or as hardware meters.

The cash-out manager 158 is a software module for managing the cash-out procedure. The cash-out manager 158 is activated in response to the player operating the cash-out button, and the gaming machine pays out the total on the credit meter in the form of cash or vouchers.

FIG. 23 to FIG. 25 are flowcharts illustrating the algorithms used for operations performed by the gaming machine. The algorithms for operating the gaming machine (the game providing method) are implemented in the game application program 92 and are realized by the CPU 38 executing the game application program 92 to generate and display the animated sequences of computer-generated images illustrated in FIGS. 6-18 on graphic user interface screens of the gaming machine 10 to display the game to the player. The operations performed by the gaming machine include a plurality of steps. Each step may be performed independently or in combination with other steps.

In step S10, when the control unit 22 accepts a game start operation from a player and a spin button operation from the player, it deducts the set total bet amount from the player credit and obtains a predetermined number of random numbers required to provide the game. Random numbers are generated internally by the random number generator 108 in the control unit 22. The control unit 22 may be configured to obtain random numbers from a random number generator installed separately from the control unit 22, or from a server or other device installed outside the gaming machine 10.

In step S12, the control unit 22 starts spinning the first through fifth reels in the first symbol display area 64. In step S14, the control unit 22 stops the spinning first reel.

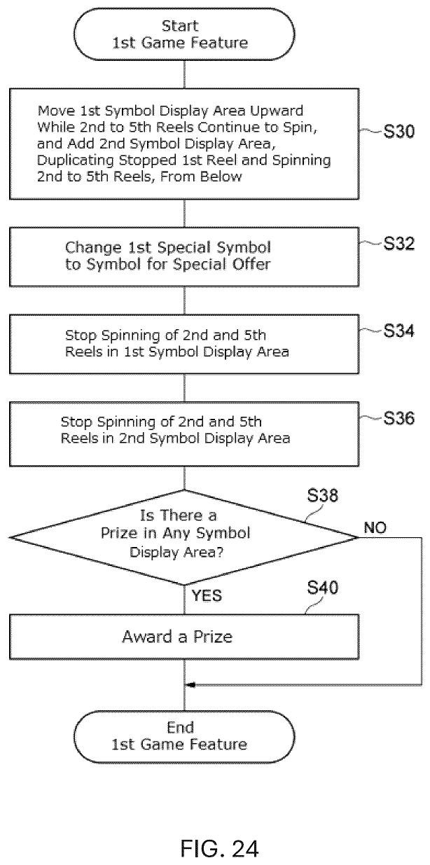

In step S16, the control unit 22 determines whether the first special symbol 851 has stopped in the first column of the first symbol display area 64. If it has been determined that the first special symbol 851 has stopped (step S16: YES), the control unit 22 offers the first game feature in step S26 (shown in FIGS. 6-9). The first game feature will be described below using FIG. 24.

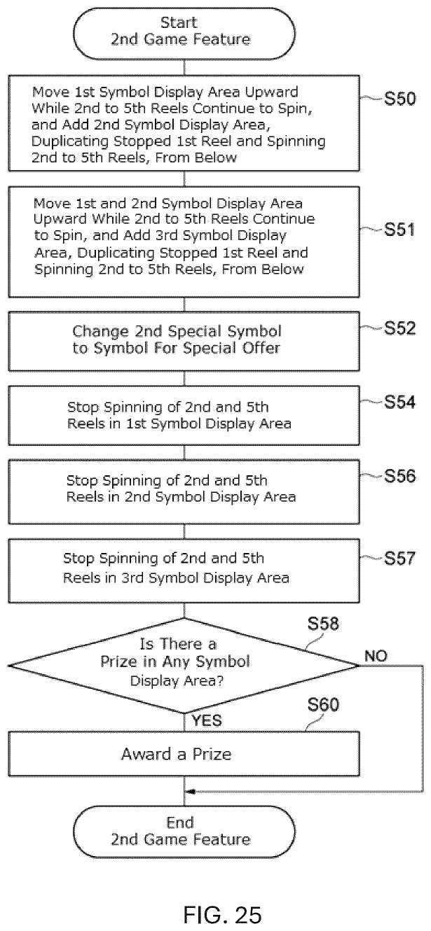

If it has been determined that the first special symbol 851 has not stopped (step S16: NO), the control unit 22 determines, in step S18, whether the second special symbol 852 has stopped in the first column of the first symbol display area 64. If it has been determined that the second special symbol 852 has stopped (step S18: YES), the control unit 22 offers the second game feature in step S28 (shown in FIGS. 10-18). The second game feature will be described below using FIG. 25.

If it has been determined that the second special symbol 852 has not stopped (step S18: NO), the control unit 22 stops the spinning second through fifth reels in the first symbol display area 64 in step S20.

In step S22, the control unit 22 determines whether the combination of symbols formed in the first symbol display area 64 has won a prize. If the combination of symbols formed in the first symbol display area 64 is determined to be a winning combination (step S22: YES), the control unit 22 awards the player a prize in step S24. If the combination of symbols includes a multiplier, the control unit 22 awards the player a prize with the multiplier applied. If it has been determined that the combination of symbols formed in the first symbol display area 64 is not a winning combination (step S22: NO) and if step S24 has been completed, the flowchart shown in FIG. 23 ends.

Next, the first game feature in step S26 will be described using FIG. 24. As shown in FIG. 24, in step S30, the control unit 22 moves the first symbol display area 64 upward while keeping the second through fifth reels spinning, and adds a second symbol display area 641 below that duplicates the stopped first reel and spinning second through fifth reels (shown in FIGS. 7-9).

Then, in step S32, the control unit 22 converts the displayed first special symbol 851 into a symbol that is eligible for a prize.

In step S34, the control unit 22 stops the spinning second through fifth reels in the first symbol display area 64. In step S36, the control unit 22 stops the spinning second through fifth reels in the second symbol display area 641.

In step S38, the control unit 22 determines whether the combinations of symbols formed in the first symbol display area 64 and the second symbol display area 641 have won a prize. If a combination of symbols formed is determined to be a winning combination (step S38: YES), the control unit 22 awards the player a prize in step S40. If a combination of symbols includes a multiplier, the control unit 22 awards the player an prize with the multiplier applied. If it has been determined that no combination of symbols is a winning combination (step S38: NO) and if step S40 has been completed, the flowchart shown in FIG. 24 ends.

Next, the second game feature in step S28 will be described using FIG. 25. As shown in FIG. 25, in step S50, the control unit 22 moves the first symbol display area 64 upward while keeping the second through fifth reels spinning, and adds a second symbol display area 641 below that duplicates the stopped first reel and spinning second through fifth reels.

Next, in step S51, the control unit 22 moves the first symbol display area 64 and the second symbol display area 641 upward while keeping the second through fifth reels spinning, and adds a third symbol display area 642 below that duplicates the stopped first reel and spinning second through fifth reels (shown in FIGS. 10-13).

Then, in step S52, the control unit 22 converts the displayed second special symbol 852 into a symbol that is eligible for a prize.

In step S54, the control unit 22 stops the spinning second through fifth reels in the first symbol display area 64. In step S56, the control unit 22 stops the spinning second through fifth reels in the second symbol display area 641. In step S57, the control unit 22 stops the spinning second through fifth reels in the third symbol display area 642.

In step S58, the control unit 22 determines whether any of the combinations of symbols formed in the first symbol display area 64, the second symbol display area 641, and the third symbol display area 642 have won a prize. If any of the combinations of symbols has been determined to be a winning combination (step S58: YES), the control unit 22 grants the player a prize in step S60. If a combination of symbols includes a multiplier, the control unit 22 awards the player a prize with the multiplier applied. If it has been determined that no combination of symbols is a winning combination (step S58: NO) and if step S60 has been completed, the flowchart shown in FIG. 25 ends.

In the gaming machine 10 described above, the number of additional symbol display areas associated with a special symbol 85 is duplicated on each reel in response to the appearance of the special symbol 85, and the additional symbol display areas include symbols that are eligible for a prize. As a result, the gaming machine 10 can create a high sense of anticipation in the player and sustain interest in the game results. In the embodiments described above, a single additional symbol display area (an example of a first number) is displayed for the first special symbol 851, and two additional symbol display areas (an example of a second number) are displayed for the second special symbol 852. However, the number of additional symbol display areas is not limited to 1 and 2, but can be any number.

The gaming machine 10 may be a client computing device, in which case the game is delivered from a network server computer system to one or more client computing devices via a communications network. Here, the processor in the client computing device can be programmed to function as the control unit 22 of the gaming machine 10.

When the gaming machine 10 is a client computing device, it can be used as part of 1) a rich client system in which the client performs most of the processing involved in game execution and sends the results to the server, 2) a thin client system in which only minimal processing is done on the client side and the main processing is done on the server side, or 3) a zero client system in which the server does most of the data storage and processing and the client specializes in input and output.

In the embodiments described above, each column of cells in the grid 68 is associated with a virtual reel strip 72-80, but it is also possible to associate an independent reel with each of the cells.

The functions of the control unit 22 of the gaming machine 10 described above can also be realized by a computer executing a program. In other words, a program can be created to make one or more computers function in the same way as the control unit 22 described above. The program can, for example, be recorded and provided on a computer-readable recording medium, such as ROM or semiconductor memory. The program may also be divided into multiple modules.

Variations on the operations in the embodiment described above are also possible. For example, the reel stop positions can be determined by obtaining a necessary number of random numbers in advance, and special game winners and prize winners can be determined and then displayed sequentially on the display. Also, the control unit 22 may obtain the required number of random numbers in a batch at the start of a game and store the random numbers in the memory area of the memory 42 or storage 44 that is not erased in the event of a power failure. In this way, if a power failure occurs during a game, the control unit 22 can reproduce the progress of the game by retrieving the random numbers obtained at the start of the game before the power failure from the memory 42 or storage 44 once the game is restarted after power is restored. For example, if a power failure occurs just before a game result with a high payout ends, there could be a problem if the same game cannot be resumed after power is restored. The problem can be avoided by acquiring all random numbers at the start of the game as described above and saving the random numbers in the memory 42 or storage 44, so that after power is restored, the game progress can be resumed as it was before the power failure occurred.

In the embodiments described above, banknotes or tickets are used to indicate the game value, banknotes or tickets are accepted by a banknote/ticket identifying device, and a ticket is outputted by a printer unit. However, the concept of game value includes tangible objects such as coins, paper money, coins, medals, and tickets, as well as electronic data such as virtual credits and virtual currency of equivalent value. For example, a coin acceptor can accept coins and pay out coins from a coin hopper. Also, a system may be designed to identify players and credits accumulated in an account on a server, and pay out credits to the account. The system may read credit information recorded on a magnetic card, IC card, or other storage medium, and pay out credits by writing them to the storage medium. In addition, credit may be transferred electronically to and from a smartphone or wearable device.

In the embodiments described above, the special reel was stopped first, but the technical concept of the present invention can also be applied to a situation in which the special reel is stopped second or later. In this case, the game may be configured to trigger the first or second game feature in response to a special symbol stopping on the second or later special reel. The game may also be applied to a situation in which a plurality of special reels is used. In this case, the game may be configured to trigger the first or second game feature in response to a special symbol stopping on any of the first through fifth reels.

### REFERENCE NUMBERS

10: Gaming machine
16: Display (example of a display unit)
22: Control unit
42: Memory (an example of a storage unit)
44: Storage (an example of a storage unit)
64: First symbol display area
641: Second symbol display area
642: Third symbol display area

What is claimed is:

1. A gaming machine comprising:
a control panel that accepts player operations;
a display unit including a display screen displaying computer-generated images thereon; and
a control unit operably coupled to the control panel and the display unit, the control unit including one or more processors programmed to execute an algorithm to display an animated sequence of computer-generated images on the display screen including the steps of:
displaying a first symbol display area on the display screen that partially displays a plurality of reels each having symbols, the plurality of reels including a special reel having a first special symbol and a second special symbol;
spinning the plurality of reels in response to a player operating the control panel;
stopping the special reel first among the plurality of reels spun in the first symbol display area;
duplicating and displaying a first number of additional symbol display ranges for each of the plurality of reels when the first special symbol stops on the special reel; and
duplicating and displaying a second number of additional symbol display ranges for each of the plurality of reels when the second special symbol stops on the special reel.

2. The gaming machine of claim 1, wherein the one or more processors is programmed to execute the algorithm including the steps of:
animating, in response to the first special symbol stopping on the special reel, a second symbol display area onto the display screen that duplicates the special reel that has been stopped in the first symbol display area and the reels that are spinning; and
stopping the remaining reels that are spinning in the first symbol display area and the second symbol display area.

3. The gaming machine of claim 2, wherein the one or more processors is programmed to execute the algorithm including the steps of:
converting the special symbols displayed in the first symbol display area and the second symbol display area into prize symbols that are eligible for a prize, before the remaining reels spinning in the first symbol display area and second symbol display area have been stopped.

4. The gaming machine of claim 2, wherein the one or more processors is programmed to execute the algorithm including the steps of:
animating, in response to the second special symbol stopping on the special reel, the second symbol display area and a third symbol display area onto the display screen that duplicates the special reel that has been stopped in the first symbol display area and the reels that are spinning; and
stopping the remaining reels that are spinning in the first symbol display area, the second symbol display area, and the third symbol display area.

5. The gaming machine of claim 4, wherein the one or more processors is programmed to execute the algorithm including the steps of:
converting the special symbols displayed in the first symbol display area, the second symbol display area, and the third symbol display area into prize symbols that are eligible for prizes before the remaining reels spinning in the first symbol display area, the second symbol display area and the third symbol display area have been stopped.

6. The gaming machine of claim 5, wherein the one or more processors is programmed to execute the algorithm including the steps of:
stopping all reels spinning in the first symbol display area;
copying symbols from one or more stopped reels of the first symbol display area if prize symbols that are eligible for a prize is displayed in the one or more stopped reels in the first symbol display area; and
duplicating and displaying the copied symbols onto corresponding reels in the second symbol display area.

7. The gaming machine of claim 6, wherein the one or more processors is programmed to execute the algorithm including the steps of:
stopping remaining reels spinning in the second reels symbol display area;
copying symbols from one or more stopped reels in the second symbol display area displaying prize symbols; and
duplicating and displaying the copied symbols the second symbol display area onto corresponding reels in the third symbol display area.

8. A method of operating a gaming machine including a control panel that accepts player operations, a display unit including a display screen displaying computer-generated images thereon, and a control unit including one or more processors operably coupled to the control panel and the display unit, the method including the one or more processors performing an algorithm to display an animated sequence of computer-generated images on the display screen including the steps of:
displaying a first symbol display area on the display screen that partially displays a plurality of reels each having symbols, the plurality of reels including a special reel having a first special symbol and a second special symbol;
spinning the plurality of reels in response to a player operating the control panel;
stopping the special reel first among the plurality of reels spun in the first symbol display area;
duplicating and displaying a first number of additional symbol display ranges for each of the plurality of reels when the first special symbol stops on the special reel; and
duplicating and displaying a second number of additional symbol display ranges for each of the plurality of reels when the second special symbol stops on the special reel.

9. The method of claim 8, including the one or more processors performing the algorithm including the steps of:
animating, in response to the first special symbol stopping on the special reel, a second symbol display area onto the display screen that duplicates the special reel that has been stopped in the first symbol display area and the reels that are spinning; and
stopping the remaining reels that are spinning in the first symbol display area and the second symbol display area.

10. The method of claim 9, including the one or more processors performing the algorithm including the steps of:
converting the special symbols displayed in the first symbol display area and the second symbol display area into prize symbols that are eligible for a prize, before the remaining reels spinning in the first symbol display area and second symbol display area have been stopped.

11. The method of claim 9, including the one or more processors performing the algorithm including the steps of:
animating, in response to the second special symbol stopping on the special reel, the second symbol display area and a third symbol display area onto the display screen that duplicates the special reel that has been stopped in the first symbol display area and the reels that are spinning; and
stopping the remaining reels that are spinning in the first symbol display area, the second symbol display area, and the third symbol display area.

12. The method of claim 11, including the one or more processors performing the algorithm including the steps of:
converting the special symbols displayed in the first symbol display area, the second symbol display area, and the third symbol display area into prize symbols that are eligible for prizes before the remaining reels spinning in the first symbol display area, the second symbol display area and the third symbol display area have been stopped.

13. The method of claim 12, including the one or more processors performing the algorithm including the steps of:
stopping all reels spinning in the first symbol display area;
copying symbols from one or more stopped reels of the first symbol display area if prize symbols that are eligible for a prize is displayed in the one or more stopped reels in the first symbol display area; and
duplicating and displaying the copied symbols onto corresponding reels in the second symbol display area.

14. The method of claim 13, including the one or more processors performing the algorithm including the steps of:
stopping remaining reels spinning in the second reels symbol display area;
copying symbols from one or more stopped reels in the second symbol display area displaying prize symbols; and
duplicating and displaying the copied symbols the second symbol display area onto corresponding reels in the third symbol display area.

15. A non-transitory computer-readable storage media having computer-executable instructions embodied thereon to operate a gaming machine including a control panel that accepts player operations, a display unit including a display screen displaying computer-generated images thereon, and a control unit including one or more processors operably coupled to the control panel and the display unit, when executed by the one or more processors the computer-executable instructions cause the one or more processors to perform an algorithm to render an animated sequence of computer-generated images on the display screen including the steps of:
displaying a first symbol display area on the display screen that partially displays a plurality of reels each having symbols, the plurality of reels including a special reel having a first special symbol and a second special symbol;
spinning the plurality of reels in response to a player operating the control panel;
stopping the special reel first among the plurality of reels spun in the first symbol display area;
duplicating and displaying a first number of additional symbol display ranges for each of the plurality of reels when the first special symbol stops on the special reel; and
duplicating and displaying a second number of additional symbol display ranges for each of the plurality of reels when the second special symbol stops on the special reel.

16. The non-transitory computer-readable storage media of claim 15, wherein the computer-executable instructions cause the one or more processors to perform the algorithm including the steps of:
animating, in response to the first special symbol stopping on the special reel, a second symbol display area onto the display screen that duplicates the special reel that has been stopped in the first symbol display area and the reels that are spinning; and
stopping the remaining reels that are spinning in the first symbol display area and the second symbol display area.

17. The non-transitory computer-readable storage media of claim 16, wherein the computer-executable instructions cause the one or more processors to perform the algorithm including the steps of:
converting the special symbols displayed in the first symbol display area and the second symbol display area into prize symbols that are eligible for a prize, before the remaining reels spinning in the first symbol display area and second symbol display area have been stopped.

18. The non-transitory computer-readable storage media of claim 16, wherein the computer-executable instructions cause the one or more processors to perform the algorithm including the steps of:
animating, in response to the second special symbol stopping on the special reel, the second symbol display area and a third symbol display area onto the display screen that duplicates the special reel that has been stopped in the first symbol display area and the reels that are spinning; and
stopping the remaining reels that are spinning in the first symbol display area, the second symbol display area, and the third symbol display area.

19. The non-transitory computer-readable storage media of claim 18, wherein the computer-executable instructions cause the one or more processors to perform the algorithm including the steps of:
converting the special symbols displayed in the first symbol display area, the second symbol display area, and the third symbol display area into prize symbols that are eligible for prizes before the remaining reels spinning in the first symbol display area, the second symbol display area and the third symbol display area have been stopped.

20. The non-transitory computer-readable storage media of claim 19, wherein the computer-executable instructions cause the one or more processors to perform the algorithm including the steps of:
stopping all reels spinning in the first symbol display area;
copying symbols from one or more stopped reels of the first symbol display area if prize symbols that are eligible for a prize is displayed in the one or more stopped reels in the first symbol display area; and
duplicating and displaying the copied symbols onto corresponding reels in the second symbol display area.
